(19) United States
(12) Patent Application Publication
(10) Pub. No.: US 2026/0128928 A1
(43) Pub. Date: May 7, 2026

(54) SYSTEM AND METHODS FOR SUPPRESSING CHANNEL REPLICA

(71) Applicant: Qorvo US, Inc., Greensboro, NC (US)

(72) Inventors: Igor Dotlic, Dublin (IE); Michael McLaughlin, Dublin (IE)

(21) Appl. No.: 19/371,442

(22) Filed: Oct. 28, 2025

Related U.S. Application Data
(60) Provisional application No. 63/716,525, filed on Nov. 5, 2024.

(51) Int. Cl. H04L 25/02; H04B 1/00

(52) U.S. Cl. CPC H04L 25/0212; H04B 1/0028; H04L 25/0242

(57) ABSTRACT

Embodiments of the present disclosure provide a method for suppressing channel replica caused by carrier frequency offset (CFO). The method includes: generating, by an analog-to-digital converter (ADC), a plurality of samples after receiving a sequence of chips by an antenna; accumulating, by an accumulator, the plurality of samples to generate an initial channel impulse response (CIR); comparing the CFO with a threshold value; in response to the CFO being greater than the threshold value, applying a filtering operation on the initial CIR estimate, the filtering operation configured to reduce an intensity of a sidelobe in the initial CIR estimate while maintaining an intensity of a main lobe in the initial CIR estimate; and generating a final estimated CIR based on the filtered initial CIR estimate.

### RELATED APPLICATION

The present application claims the benefit of U.S. Provisional Application No. 63/716,525, entitled “SYSTEM AND METHODS FOR SUPPRESSING CHANNEL REPLICA” and filed on Nov. 5, 2024, which is hereby incorporated by reference in its entirety.

### FIELD OF THE INVENTION

This disclosure relates to radio frequency (RF) communication technologies. In particular, this disclosure relates to a system and methods for suppressing channel replica.

### BACKGROUND

Ultra-Wideband (UWB) is a wireless communication technology characterized by its ability to transmit data over a wide frequency spectrum, typically greater than 500 MHz. Unlike traditional wireless technologies that use narrow frequency bands, UWB operates by transmitting short, low-power pulses across a broad range of frequencies. This enables high data rates, precise localization capabilities, and low power consumption, making UWB a versatile technology with a wide range of applications such as positioning and localization, consumer electronics, Internet of Things (IoT), security and access control, etc.

Synchronization header (SHR) is an important part of a UWB frame structure that helps a receiver synchronize with transmitter, and detect and process the receive UWB signal, in the UWB communication. SHR often includes a preamble and a start frame delimiter (SFD). The preamble includes a sequence of pulses or symbols transmitted at the start of the SHR. The sequence can enable the receiver to detect the presence of the signal, achieve timing synchronization between the receiver and the signal, and estimate and correcting carrier frequency offset (CFO) between the transmitter and the receiver. The sequence can be accumulated to generate a channel impulse response (CIR) which is later used to determine parameters such as time-of-arrival (ToA), for determining a distance between the transmitter and the receiver. However, the CIR can be noisy, and the precision of ToA can be low due to the noise.

Therefore, there is a need to improve the precision of CIR to increase the precision of ToA.

### SUMMARY

Embodiments of the present disclosure provide a method for suppressing channel replica caused by carrier frequency offset (CFO). The method includes: generating, by an analog-to-digital converter (ADC), a plurality of samples after receiving a sequence of chips by an antenna; accumulating, by an accumulator, the plurality of samples to generate an initial channel impulse response (CIR); comparing the CFO with a threshold value; in response to the CFO being greater than the threshold value, applying a filtering operation on the initial CIR estimate, the filtering operation configured to reduce an intensity of a sidelobe in the initial CIR estimate while maintaining an intensity of a main lobe in the initial CIR estimate; and generating a final estimated CIR based on the filtered initial CIR estimate.

In some embodiments, the method further includes: determining an ambiguity function of the sequence; determining an analytical model of the initial CIR estimate based on the ambiguity function and a channel response of the sequence; and generating a set of filter coefficient vectors of the filter based on the ambiguity function, wherein the set of the filter coefficient vectors each correspond to a respective one of the plurality of samples.

In some embodiments, the applying of the filtering operation comprises generating an inner product of each of the filter coefficient vector with the initial CIR estimate.

In some embodiments, the ambiguity function comprises samples arranged in a Toeplitz matrix and comprises a pseudo-circulant matrix.

In some embodiments, the generating of the set of filter coefficient vectors includes: generating one filter coefficient vector of the filter coefficient vectors; and generating an adjacent filter coefficient vector of the one filter coefficient vectors based on the pseudo-circulant matrix.

In some embodiments, the generating of the set of filter coefficients includes: generating a first filter coefficient vector of the filter coefficient vectors; and generating a next filter coefficient vector by: multiplying a last element of a previous filter coefficient vector with a phase factor to generate a product, and shifting the product to be a first element and a remaining of elements by one position to the right.

In some embodiments, the generating of the set of filter coefficient vectors includes: generating a last filter coefficient vector of the filter coefficient vectors; and generating a previous filter coefficient vector by: multiplying a first element of a next filter coefficient vector with a phase factor to generate a product, and shifting the product to be a last element and a remaining of elements by one position to the left.

In some embodiments, a first filter coefficient vector or a last filter coefficient vector is pre-computed based on a total sidelobe suppression or a convex optimization.

In some embodiments, the shifting is performed in a shift register.

In some embodiments, the sequence comprises a synchronization header (SHR) of a radio frequency (RF) packet.

In some embodiments, the method further includes computing one or more of a time of arrival (ToA) or a position of arrival (PoA) based on the final CIR estimate.

Embodiments of the present disclosure provide an ultra-wideband (UWB) device, which includes a UWB receiver having an analog-to-digital converter (ADC). The UWB receiver is configured to: generate, by the ADC, a plurality of samples after receiving a sequence of chips by an antenna; accumulate, by an accumulator, the plurality of samples to generate an initial channel impulse response (CIR) estimate; compare the CFO with a threshold value; in response to the CFO being greater than the threshold value, apply a filtering operation on the initial CIR, the filtering operation configured to reduce an intensity of a sidelobe in the initial CIR estimate while maintaining an intensity of a main lobe in the initial CIR estimate; and generate a final estimated CIR based on the filtered initial CIR estimate.

In some embodiments, the UWB receiver is further configured to: determine an ambiguity function of the sequence; determine an analytical model of the initial CIR estimate based on the ambiguity function; and generate a set of filter coefficient vectors of the filter based on the ambiguity function, wherein the set of the filter coefficient vectors each correspond to a respective one of the plurality of samples.

In some embodiments, to apply the filtering operation comprises generating an inner product of each of the filter coefficient vector with a respective part of the initial CIR estimate that corresponds to the respective one of the plurality of samples.

In some embodiments, the ambiguity function comprise samples arranged in a Toeplitz matrix and comprises a pseudo-circulant matrix.

In some embodiments, to generate the set of filter coefficient vectors comprises: generating one filter coefficient vector of the filter coefficient vectors; and generating an adjacent filter coefficient vector of the one filter coefficient vectors based on the pseudo-circulant matrix.

In some embodiments, to generate the set of filter coefficients comprises: generating a first filter coefficient vector of the filter coefficient vectors; and generating a next filter coefficient vector by: multiplying a last element of a previous filter coefficient vector with a phase factor to generate a product, and shifting the product to be a first element and a remaining of elements by one position to the right.

In some embodiments, to generate the set of filter coefficient vectors comprises: generating a last filter coefficient vector of the filter coefficient vectors; and generating a previous filter coefficient vector by: multiplying a first element of a next filter coefficient vector with a phase factor to generate a product, and shifting the product to be a last element and a remaining of elements by one position to the left.

In some embodiments, the shifting is performed in a shift register.

Embodiments of the present disclosure provide a non-transitory computer-readable medium (CRM) having program code recorded thereon. The program code includes: code for causing an ultra-wide band (UWB) device to generate, by an analog-to-digital converter (ADC), a plurality of samples after receiving a sequence of chips by an antenna; code for causing the UWB device to accumulate, by an accumulator, the plurality of samples to generate an initial channel impulse response (CIR); and code for causing the UWB device to compare the CFO with a threshold value. The program code also includes code for causing the UWB device to, in response to the CFO being greater than the threshold value, apply a filtering operation on the initial CIR estimate, the filtering operation configured to reduce an intensity of a sidelobe in the initial CIR estimate while maintaining an intensity of a main lobe in the initial CIR estimate. The program code further includes code for causing the UWB device to generate an estimated CIR based on the filtered initial CIR estimate.

### BRIEF DESCRIPTION OF THE DRAWINGS

FIG. 1 illustrates an exemplary receiver having a post-processing module, according to embodiments of the present disclosure.

FIG. 2 illustrates an example of an ambiguity function of a SHR sequence, according to embodiments of the present disclosure.

FIG. 3A illustrates an exemplary implementation to generate a coefficient vector, according to embodiments of the present disclosure.

FIG. 3B illustrates another exemplary implementation to generate a coefficient vector, according to embodiments of the present disclosure.

FIG. 4 illustrates an exemplary process to determine a start of a filtering operation, according to embodiments of the present disclosure.

FIG. 5A shows an exemplary process to generate a coefficient vector corresponding to the implementation in FIG. 3A, according to embodiments of the present disclosure.

FIG. 5B shows another exemplary process to generate a coefficient vector corresponding to the implementation in FIG. 3B, according to embodiments of the present disclosure.

FIG. 6 illustrates an exemplary filtering process on an output of an accumulator, according to embodiments of the present disclosure.

FIGS. 7A-7C show simulation results of a frequency channel with an ideal CIR, an initial CIR estimate with a main lobe and sidelobes, and final CIR estimate with a main lobe and suppressed sidelobes, respectively, according to embodiments of the present disclosure.

### DETAILED DESCRIPTION

The following detailed description is illustrative in nature and is not intended to limit the scope, applicability, or configuration of inventive embodiments disclosed herein in any way. Rather, the following description provides practical examples, and those skilled in the art will recognize that some of the examples may have suitable alternatives. Embodiments will hereinafter be described in conjunction with the appended drawings, which are not to scale (unless so stated), wherein like numerals/letters denote like elements. However, it will be understood that the use of a number to refer to a component in a given drawing is not intended to limit the component in another drawing labeled with the same number. In addition, the use of different numbers to refer to components in different drawings is not intended to indicate that the different numbered components cannot be the same or similar to other numbered components. Examples of constructions, materials, dimensions and fabrication processes are provided for select elements and all other elements employ that which is known by those skilled in the art.

As used herein, the term “about” refers to a given amount of value that may vary based on the particular technology node associated with the semiconductor device. Based on a particular technology node, the term “about” can refer to a given amount of value that varies, for example, within 10-30% of the value (e.g., ±10%, ±20%, or ±20% of that value, or ±30%).

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Reference will now be made in greater detail to various embodiments of the subject matter of the present disclosure, some embodiments of which are illustrated in the accompanying drawings.

Performance limitations of the SHR over the CFO, due to the correlation before the CFO removal, is a known problem in UWB technology. The cause of the problem is found in the periodic sequence being distorted by the CFO before the correlation. The sequence loses its favorable periodic autocorrelation (PACR) properties giving rise to sidelobes, which manifest as CIR replica or channel replica in the accumulator. The channel replica can limit the detection performance of the weaker paths, since they can be hidden in the sidelobes of the stronger paths.

Previous effort has been made to alleviate the problem in the correlator domain or de-rotation domain. However, these approaches often require a more complex architecture of the receiver. The complexity of the approaches can make it more costly to be implemented in the existing receiver architecture.

Embodiments of the present disclosure provide a novel method of per accumulator path linear filtering. Specifically, the output (e.g., initial CIR estimate) of an accumulator undergoes a post-processing filtering that suppresses (“filters out”) the sidelobes in the output and maintains the intensity of the main lobe. The generated final CIR estimate, which is an estimate of the initial CIR estimate, can be used to determine parameters such as ToA with higher precision due to the suppression of sidelobes. Because the sidelobes are suppressed, information on the path can be more accurately obtained. Accordingly, parameters (e.g., ToA) calculated based on the final CIR estimate can have improved accuracy and precision. Also, the module for implementing the post-processing filtering is compatible with the existing receiver architecture. For example, the module can process/filter the output of an existing accumulator to provide a final CIR estimate with suppressed sidelobes. The cost to implement the filtering operation is thus minimized.

The method of the present disclosure includes determining an analytical model of the output of the accumulator based on an ambiguity function of the SHR sequence, and generating filter coefficients for the post-processing filtering based on the ambiguity function. The method also includes applying the filter coefficients on the output of the accumulator to suppress the sidelobes (e.g., channel replica) while maintaining the main lobe. Specifically, the filter coefficients (e.g., coefficient vectors) may iteratively change per accumulator path in a pseudo-circular fashion, consistent with the analytical model of the accumulator. The reason why this technique effectively suppress the sidelobes can be found in the analytical model of the output of the accumulator, which is partly based on an ambiguity function of the sequence and includes pseudo-circulation characteristics. The filter coefficients, which are vectors corresponding to respective samples, can be pre-computed in a computer or by a shift register.

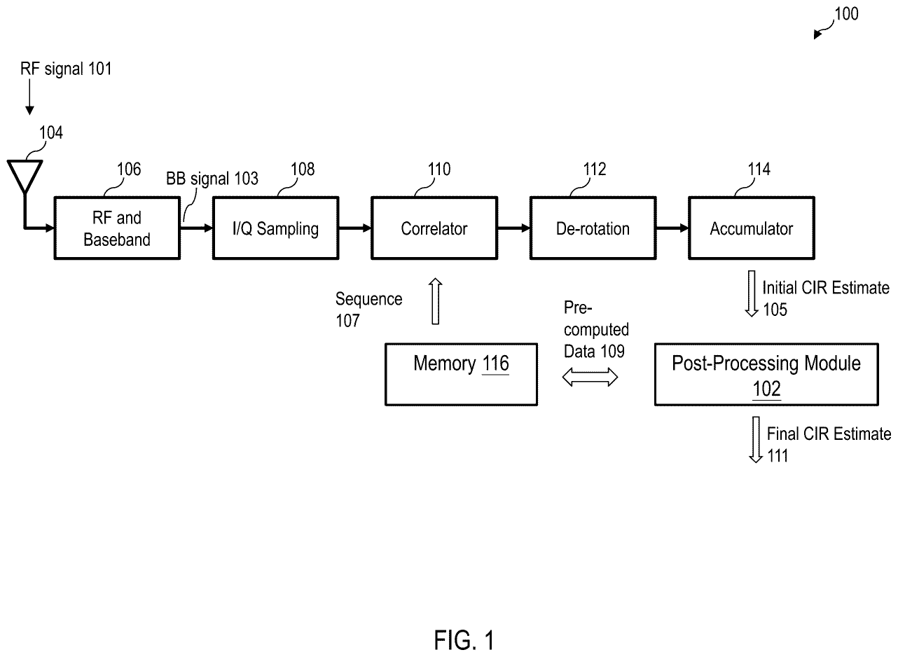

FIG. 1 shows an exemplary architecture of a receiver 100 provided by the disclosure. In some embodiments, receiver 100 represents a ultra-wide band (UWB) receiver configured to receive UWB signals. Receiver 100 may include an antenna 104, a RF and Baseband (BB) processing module 106, an in-phase/quadrature (I/Q) sampling circuit 108, a correlator 110, a de-rotation module 112, an accumulator 114, and a memory 116. Antenna 104 may receive a RF signal 101, which may include a SHR that includes a sequence of chips (e.g., +1 and −1 pulses in the UWB regime). In some embodiments, the sequence may include a ternary codeword that has perfect periodic auto-correlation (PACR). For example, the sequence may include an Ipatov sequence. RF and Baseband processing circuit 106 may take the received RF signal 101 and provides front-end processing (e.g., amplification, filtering, down conversion to a BB signal 103) and passes BB signal 103 to I/Q sampling circuit 108. A sampled BB sequence may be transmitted to correlator 110. Correlator 110 may correlate the sampled BB sequence and a sequence 107 generated by receiver 100. In some embodiments, sequence 107 is pre-stored in memory 116, and may be accessed by correlator 110 for the correlation. After the cross-correlation, the correlated signal may be transmitted to a de-rotation module 112, which may detect the CFO and apply a phase rotation to the correlated signal such that it is aligned with the clock of receiver 100. The de-rotated signal may then be transmitted to accumulator 114 to be accumulated. An initial CIR estimate 105 may be generated by accumulator 114. As mentioned above, CFO may distort the input signal of accumulator 114, resulting sidelobes (e.g., replica) in initial CIR estimate 105.

Receiver 100 may further include a post-processing module 102 that receives initial CIR estimate 105, performs a filtering operation on initial CIR estimate 105, and generates a final CIR estimate 111. To generate final CIR estimate 111, post-processing module 102 may access pre-computed data 109 from memory 116. In some embodiments, pre-computed data 109 includes an ambiguity function of the sequence, an analytical model of the output of accumulator 114, and filter coefficients (e.g., coefficient vectors) for the filtering operation. Final CIR estimate 111 may be a filtered/processed version of initial CIR estimate 105. Compared to initial CIR estimate 105, final CIR estimate 111 may have a main lobe of similar intensity and sidelobes of reduced intensity. For example, the intensity of sidelobes can be reduced by at least about 30 dB or approximately 32 times. In other words, sidelobes are suppressed in final CIR estimate 111, e.g., for the detection of weaker, useful paths. In the present disclosure, the analytical model of the output of accumulator 114, as well as the filter coefficients are pre-computed and pre-stored. Although not shown, final CIR estimate 111 may be used to further compute other parameters such as ToA, position of arrival (PoA), etc.

In some embodiments, post-processing module 102 may include a processor, such as a central processing unit (CPU), a graphics processing unit (GPU), and/or a microprocessor. Memory 116 may include a random-access memory (RAM), a read-only memory (ROM), an electrically erasable programmable ROM (EEPROM), an optical disk storage, a magnetic disk storage, and/or the like. Operating software, data, and/or signal symbols may be stored/buffered in memory 116 for use.

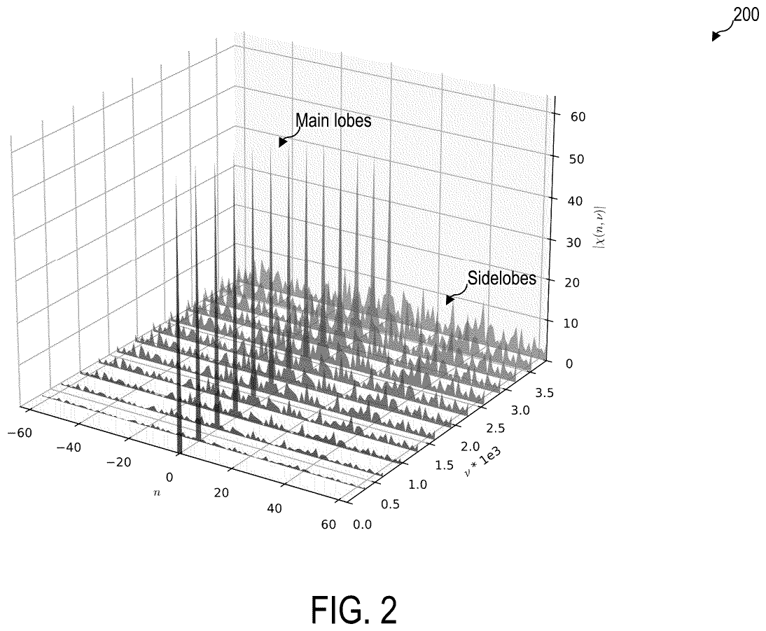

FIG. 2 shows an example of an ambiguity function 200 of a sequence, according to some embodiments. Ambiguity function 200 may be used to compute the analytical model of the output of an accumulator, which can be an example of accumulator 114. Ambiguity function 200 may depend on the sequence (e.g., a ternary codeword with a perfect PACR) and frequency. As shown in FIG. 2, ambiguity function 200 may be a function of sample number (n) and CFO (v). It should be noted that, ambiguity function 200 is merely an example, and is not meant to scale or indicate the true values associated with a sequence. The generation of ambiguity function 200 and the analytical model of the output of accumulator 114 are shown in equations (1)-(12). In some embodiments, the analytical model of the output of accumulator 114 and/or ambiguity function 200 may be pre-computed by post-processing module 102 and may be stored in memory 116 (e.g., as pre-computed data 109) prior to the filtering operation.

It is assumed that a transmitter transmits s(n) as an infinite periodic preamble, to receiver 100. s(n) may modulated by a CFO, which denoted v. In the baseband discrete-time transmitter equivalent, s(n) may be represented by equation (1):

$$s ( n , ν ) = a ( n mod M ) exp ( 2 j πν n ) , \qquad ( 1 )$$

for −∞<n<+∞. In equation (1), a(n) is the preamble codeword of length M and v is a discrete-time frequency of CFO. s(n) may pass through the channel with the complex discrete-time baseband-equivalent channel impulse response (CIR) h(n), which includes both transmitter and receiver impulse responses.

Transmitter and receiver 100 may be coarsely synchronized at the time of CIR estimation, therefore, h(n) can be non-zero only for 0≤n≤M−1.

At the receiver, s(n) and h(n) may produce a baseband-equivalent complex signal r(n, v):

$$r ( n , ν ) = s ( n , ν ) ⊗ h ( n ) , \qquad ( 2 )$$

where ‘⊗’ denotes convolution.

The received signal goes through the correlator with the impulse response a*(−n) to produce the signal c(n, v):

$$c ( n , ν ) = r ( n , ν ) ⊗ {a}^{*} ( - n ) . \qquad ( 3 )$$

Equation (3) can be rearranged as

$$c ( n , ν ) = χ ( n , ν ) ⊗ h ( n ) . \qquad ( 4 )$$

Here, χ(n, v) may represent periodic ambiguity function (PAF) of a(n) with a single integration period, as disclosed by Freedman et al. (A. Freedman and N. Levanon, “Properties of the periodic ambiguity function,” IEEE Transactions on Aerospace and Electronic Systems, vol. 30, pp. 938-941, July 1994.) and Levanon (N. Levanon, “The periodic ambiguity function—Its validity and value,” in 2010 IEEE Radar Conference, 2010.):

$$χ ( n , ν ) = [ a ( n mod M ) exp ( 2 j πν n ) ] ⊗ {a}^{*} ( - n ) = {e}^{2 π jn ν} {\sum }_{k = 0}^{M - 1} {a}^{*} ( k ) a ( ( n + k ) mod M ) ) {e}^{2 π j ν k} , \qquad ( 5 )$$

for −∞<n<+∞.

A property of χ(n, v), derived from (5), may be its pseudo-periodicity in time, as shown in equation (6):

$$χ ( n + kM , ν ) = exp ( jk φ ) χ ( n , ν ) , \qquad ( 6 )$$

for integer k and φ=2πvM.

The pseudo-periodicity property can be exploited in the rotation and accumulation. For example, receiver 100 may rotate and accumulate K preamble symbols at the output of correlator 110 to obtain the scaled channel estimate, which is also referred to the output of an accumulator, denoted g(n, v):

$$g ( n , ν ) = {\sum }_{k = 0}^{K - 1} c ( n + Mk , ν ) exp ( - jk φ ) = K χ ( n , ν ) ⊗ h ( n ) , \qquad ( 7 )$$

for n∈{0, 1, . . . , M−1}.

Another property of the PAF for a real sequence, derived from equation (5), is symmetry in frequency:

$$χ ( n , ν ) = {χ}^{*} ( n , - ν ) , ∀ a ( n ) ∈ . \qquad ( 8 )$$

As shown in FIG. 2, at each CFO value v, a main lobe may appear at n=0, and sidelobes may appear at other n values. It is evident that the main lobe level decreases with v. On the other hand, sidelobes level increases relatively uniformly with v. Thus, perfect PACR property, depicted for v=0, is progressively lost as v increases.

The goal of the disclosed method is to estimate a frequency channel, especially low-level paths, masked by sidelobes of high-level paths. In other words, the goal is to calculate the estimate of h(n), for n∈{0, 1, . . . , M−1}, denoted ĥ(n), from g(n, v). This can be done using filtering by post-processing module 102. The filter can be designed for each path index, and this may be done before the filtering operation, e.g., without knowing g(n, v).

Ambiguity function 200 may be used by receiver 100 to compute an analytical model of the output of accumulator 114, e.g., which can include a vector representation of accumulator 114. The analytical model may be pre-computed and pre-stored in memory 116, and may be accessed by post-processing module 102 for filtering/processing initial CIR estimate 105.

Equation (7) can be written in a column-vector form to represent the analytical model of the output of an accumulator (e.g., 114) as:

$$g ( v ) = K {\sum }_{n = 0}^{M - 1} h ( n ) {χ}_{n} ( v ) . \qquad ( 9 )$$

### Here

$$g ( v ) = {[ g ( n , v ) ]}_{n = 0}^{M - 1}$$

is the accumulator column-vector and χₙ(v), for n=0, 1, . . . , M−1, represent column-vectors of ambiguity function (or ambiguity function samples as elements of discrete-time vectors or discrete-time sequences):

$$\begin{matrix}{χ}_{0} ( v ) = {[ χ ( 0 , v ) , χ ( 1 , v ) , … , χ ( M - 1 , v ) ]}^{T} , \\ {χ}_{1} ( v ) = {[ χ ( - 1 , v ) , χ ( 0 , v ) , … , χ ( M - 2 , v ) ]}^{T} , \\ ⋮ \\ {χ}_{M - 1} ( v ) = {[ χ ( - M + 1 , v ) , χ ( - M + 2 , v ) , … , χ ( 0 , v ) ]}^{T} .\end{matrix} \qquad ( 10 )$$

Furthermore, (9) can be written in a matrix-vector form as:

$$g ( v ) = X ( v ) h . \qquad ( 11 )$$

X(v) in equation (11) may represent the ambiguity function of the sequence, and equations (9) and (11) can each represent the analytical model of the output (e.g., initial CIR estimate 105) of accumulator 114. In some embodiments, initial CIR estimate 105 includes g(v). Here,

$$h = {[ h ( n ) ]}_{n = 0}^{M - 1}$$

is the channel column-vector and X(v), which is a M×M matrix:

$$X ( v ) = [ \begin{matrix}{χ}_{0}^{T} ( v ) \\ {χ}_{1}^{T} ( v ) \\ ⋮ \\ {χ}_{M - 1}^{T} ( v )\end{matrix} ] . \qquad ( 12 )$$

In some embodiments, X(v) is a Toeplitz matrix, in which each descending diagonal from left to right is constant. Furthermore, X(v) is a pseudo-circulant matrix, as χ(−n, v)=exp(−jφ)χ(M−n,v) for n∈{1, 2, . . . , M−1}. X(v) may exhibit a structure similar to a circulant matrix but with some deviation from the strict circulant property. For a real sequence, X(v)=X*(−v) holds due to (8). In some embodiments, the pseudo-circularity property of X(v), (e.g., as part of g(v)) may be used to determine filter coefficients (e.g., coefficient vectors) of post-processing module 102.

The following pseudo-circularity property of χₙ(v) vectors can be derived from (6) and (10):

$${χ}_{n} ( v ) = \{ \begin{matrix}exp ( i φ ) P ( v ) {χ}_{M - 1} ( v ) , & for n = 0 , \\ P ( v ) {χ}_{n - 1} ( v ) , & for n = 1 , 2 , … , M - 1 .\end{matrix} \qquad ( 13 )$$

Here, P(v) represents the following pseudo-circulation matrix:

$$P ( v ) = [ \begin{matrix}{0}_{1 \times ( M - 1 )} & exp ( - j φ ) \\ {I}_{M - 1} & {0}_{( M - I ) \times 1}\end{matrix} ] . \qquad ( 14 )$$

The matrix inverse of P(v) is: P⁻¹(v)=P^{H}(v), where superscript H denotes Hermitian transposition. Therefore, [P⁻¹(v)]^{T}=P*(v) holds, as well as P^{M}(v)=exp(−jφ) I_{M}.

The filtering operation by post-processing module 102 may be described as follows. A set of M column-vector filters: wₙ(v) is defined, for n=0, 1, . . . , M−1, where:

$$K \hat{h} ( n ) = {g}^{T} ( v ) {w}_{n} ( v ) , \qquad ( 15 )$$

As shown in equation (15), wₙ(v) is designed with the aim to estimate h(n) from g(v). ĥ(n) may represent a final CIR estimate (e.g., 111) computed based on the post-processing or filtering of the initial CIR estimate (e.g., 105), and may have suppressed sidelobes to more accurately reflect the paths information of the frequency channel. In some embodiments, each wₙ(v) is referred to a filter coefficient or a coefficient vector for a respective sample being accumulated in accumulator 114. Since the initial CIR estimate (e.g., 105) is not known when designing wₙ(v), the influence of n-th path to k-th path estimate after filtering can be quantified as:

$${l}_{n , k} ( v ) = {χ}_{n}^{T} ( v ) {w}_{k} ( v ) . \qquad ( 16 )$$

In other words, l_{n=k,k}(v) may represent the main lobe, and l_{n≠k,k}(v) may represent the sidelobe.

It is noted that for a real sequence, if

$${w}_{k} ( - v ) = {w}_{k}^{*} ( v )$$

is chosen, que to (8), (16) becomes:

$${l}_{n , k} ( - v ) = {χ}_{n}^{T} ( - v ) {w}_{k} ( - v ) = {χ}_{n}^{H} ( v ) {w}_{k}^{*} ( v ) = {l}_{n , k}^{*} ( v ) . \qquad ( 17 )$$

Therefore, in this case, a coefficient vector intended for one frequency can be used for its inverse with the same results by conjugating it.

If wₖ(v) is chosen in the following way:

$${w}_{k} ( v ) = {[ {P}^{- 1} ( v ) ]}^{T} {w}_{k - 1} ( v ) = {[ {P}^{- k} ( v ) ]}^{T} {w}_{0} ( v ) , \qquad ( 18 )$$

for k=1, 2, . . . , M−1, the following main lobe and sidelobe recursion can be derived from (13), (16), and (18):

$${l}_{n , k} ( v ) = \{ \begin{matrix}{l}_{M - 1 , k - 1} ( v ) exp ( j φ ) , & for n = 0 , \\ {l}_{n - k , k - 1} ( v ) , & for 1 \leq n \leq M - 1.\end{matrix} \qquad ( 19 )$$

From the above recursion, the main lobe and the sidelobes with regards to those for k=0 are:

$${l}_{n , k} ( v ) = \{ \begin{matrix}{l}_{M + n - k , 0} ( v ) exp ( j φ ) , & for 0 \leq n < k , \\ {l}_{n - k , 0} ( v ) , & for k \leq n \leq M - 1.\end{matrix} \qquad ( 20 )$$

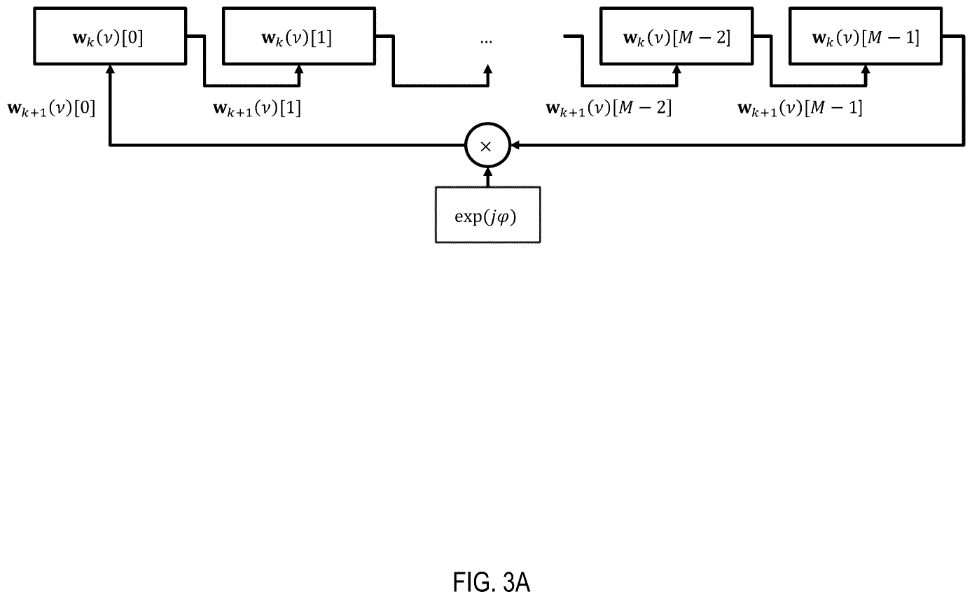

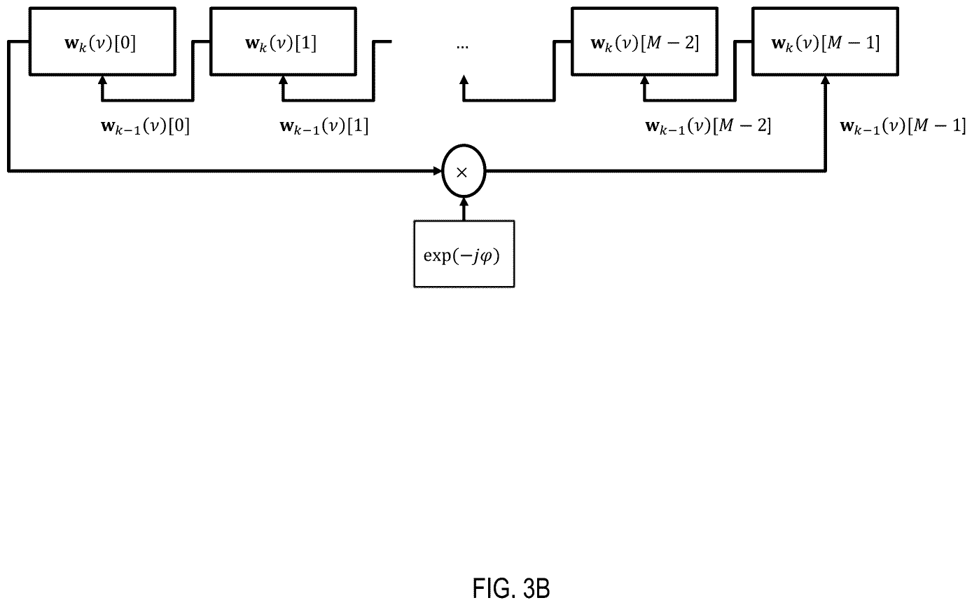

Therefore, the main lobe and the pre-cursor sidelobes (e.g., sidelobes that appear before the main lobe), when their position is viewed relatively to the main lobe, will always be the same as for k=0. On the other hand, the post-cursor sidelobes (e.g., sidelobes that appear after the main lobe), when wrapping around from the pre-cursor sidelobes, will be rotated by exp(jφ). Since the sidelobes phases are generally not important for the performance, only w₀(v) may be designed, and then equation (18) may be used to obtain wₖ(v). Another approach to implement equation (18) is circular shifting with a multiplication by exp(jφ), as shown in FIG. 3A.

FIG. 3A shows generating the coefficient vector for each sample in accumulator 114 using a “forward” approach. The elements of a coefficient vector may be shifted to the right to generate the coefficient vector of the next sample. In some embodiments, w₀(v) is generated first to generate the rest of the coefficient vectors. As shown in FIG. 3A, in accumulator 114 for accumulating M samples, for each sample (n=0, . . . , M−1), the elements of wₖ(v) may include wₖ(v)[0], wₖ(v)[1], . . . , wₖ(v)[M−1]. To generate wₖ₊₁(v), all elements of wₖ(v) may shift to the right by one element/position, and the last element wₖ(v)[M−1] may be shifted out and multiplied with a phase factor exp(jφ). The product, e.g., wₖ(v)[M−1] exp(jφ), may be shifted left and become the first element of wₖ₊₁(v), while wₖ(v)[0], . . . , wₖ(v)[M−2] may become the rest elements of wₖ₊₁(v). In some embodiments, the shifting operation can be implemented in a shift register.

For example, assuming M is equal to 6, there may be 6 coefficient vectors with indices 0-5, φ=π/2 so that exp(jφ)=1j:

$$w 0 = {[ a b c d e f ]}^{T} ,$$

$$w 1 = {[ fj a b c d e ]}^{T} ,$$

$$w 2 = {[ ej fj a b c d ]}^{T} ,$$

$$w 3 = {[ dj ej fj a b c ]}^{T} ,$$

$$w 4 = {[ cj dj ej fj a b ]}^{T} ,$$

$$w 5 = {[ bj cj dj ej fj a ]}^{T} .$$

Similarly, w_{M-1} (v) can be designed and wₖ(v) can be calculated as:

$${w}_{k} ( v ) = {[ P ( v ) ]}^{T} {w}_{k + 1} ( v ) = {[ {P}^{M - 1 - k} ( v ) ]}^{T} {w}_{M - 1} ( v ) , \qquad ( 21 )$$

for k=0, 1, . . . , M−2. FIG. 3B shows another approach to generate the coefficient vector for each sample in accumulator 114 using a “backward” approach. Different from FIG. 3A, the elements of a coefficient vector may be shifted to the opposite direction, e.g., to the left, to generate the coefficient vector of the previous sample. In some embodiments, w_{M-1}(v) is generated first to generate the rest of the coefficient vectors.

As shown in FIG. 3B, in accumulator 114 for accumulating M samples, for each sample (n=0, . . . , M−1), the elements of wₖ(v) may include wₖ(v)[0], wₖ(v)[1], . . . , wₖ(v)[M−1]. To generate wₖ₋₁ (v), all elements of wₖ(v) may shift to the left by one element/position, and the first element wₖ(v)[0] may be shifted out and multiplied with a phase factor exp(−jφ). The product, e.g., wₖ(v)[0] exp(−jφ), may be shifted right and become the last element of wₖ₋₁ (v), while wₖ(v)[1], . . . , wₖ(v)[M−1] may become the rest elements of wₖ₋₁ (v). In some embodiments, the shifting operation can be implemented in a shift register.

For example, assuming M is equal to 6, there may be 6 coefficient vectors with indices 0-5, q=π/2 so that exp(−jφ)=−1j:

$$w 5 = {[ a b c d e f ]}^{T} ,$$

$$w 4 = {[ b c d e f - aj ]}^{T} ,$$

$$w 3 = {[ c d e f - aj - bj ]}^{T} ,$$

$$w 2 = {[ d e f - aj - bj - cj ]}^{T} ,$$

$$w 1 = {[ e f - aj - bj - cj dj ]}^{T} ,$$

$$w 0 = {[ f aj - bj - cj - dj - ej ]}^{T} .$$

In some embodiments, wₖ(v) for any k∈{0, 1, . . . , M−1} can be generated first to generate the rest of the coefficient vectors. In this case, equations (18) or (21) may be used to calculate all the others. In various embodiments, calculating w₀(v) directly from w_{M-1}(v) and vice versa (e.g., as shown in equations (18) and (21)) is possible. In some embodiments, when using (18), w₀(v) can be determined as:

$${w}_{0} ( v ) = {exp ( - j φ ) [ {P}^{- 1} ( v ) ]}^{T} {w}_{M - 1} ( v ) . \qquad ( 22 )$$

In some embodiments, when using (21), which can be derived from (22), w_{M-1}(v) can be determined as:

$${w}_{M - 1} ( v ) = {exp ( j φ ) [ P ( v ) ]}^{T} {w}_{0} ( v ) . \qquad ( 23 )$$

Equations (24)-(27) are described below to show the design and calculation of w₀(v), assuming all sidelobes on a single frequency v₀ are totally suppressed. In some embodiments, w₀(v) is designed for a single frequency v₀, or an interval of frequencies v E [v₀−Δv, v₀+Δv]. In the latter case, v₀ is the central frequency of the interval and w₀(v)=w₀(v₀), ∀V∈[v₀−Δv, v₀+Δv]. In other words, the same initial coefficient vector may be used for CFO in [v₀−Δv, v₀+Δv]. It is noted that, however, that the subsequent coefficient vectors may be different, calculated using (18), which is v-dependent.

To design post-processing module 102 (e.g., the filter or the filter coefficients), signal-to-noise ratio (SNR) affected by the filtering operation is considered. The SNR may be kept in a desirably high level in the design. It can be shown that the SNR loss of the filtering, in white accumulator noise, denoted η(v), is equal to:

$$η ( v ) = \frac{\vert χ ( 0 , v ) \vert ‖ {w}_{0} ( v ) ‖}{\vert {l}_{0 , 0} ( v ) \vert} \qquad ( 24 )$$

It is noted that equation (18) keeps the energy of the filter coefficient vectors constant, as well as the main lobe level, therefore, η(v) does not change with the path index.

The scaling of the filter may be chosen so the gain of the main lobe at v₀ equals to unity:

$${l}_{0 , 0} ( {v}_{0} ) = {χ}_{0}^{T} ( {v}_{0} ) {w}_{0} ( {v}_{0} ) = χ ( 0 , {v}_{0} ) . \qquad ( 25 )$$

Therefore, from equations (24) and (25), the following may hold:

$$η ( {v}_{0} ) = ‖ {w}_{0} ( {v}_{0} ) ‖ . \qquad ( 26 )$$

In some embodiments, equation (27) may be used to totally suppress all the sidelobes on a single frequency v₀:

$${l}_{n , 0} ( {v}_{0} ) = {χ}_{n}^{T} ( {v}_{0} ) {w}_{0} ( {v}_{0} ) = 0 , \qquad ( 27 )$$

for n=1, 2, . . . , M−1.

The expressions (25) and (27) represent a system of M linear equations with M unknowns, which, generally, can be solved for w₀(v₀). It is noted that w₀(v₀) can be solved by using Levinson-Durbin recursion as X(v) is a Toeplitz matrix with a non-zero main diagonal. In some embodiments, equations (25) and/or (27) are used to compute w₀(v), which may be used in equations (18) and/or (21) to compute coefficient vectors corresponding to other samples.

In some embodiments, as there will be non-idealities of the system that will give rise to the accumulator artefacts with a certain level regardless of the input SNR, a second-order cone program (SOCP), as mentioned by Dotlic et al (I. Dotlic and R. Kohno, “Design of the Family of Orthogonal and Spectrally Efficient UWB Waveforms,” IEEE Journal of Selected Topics in Signal Processing, vol. 1, pp. 21-30, 2007.), which is convenient since it is a convex optimization method (S. Boyd and L. Vandenberghe, Convex Optimization, Cambridge University Press, 2004.) is used to compute w₀(v). By using the convex optimization method, w₀(v) may converge to the unique optimal solution, provided the problem is solvable. As an example, peak sidelobe level can be constrained to be below a certain level, which should be chosen to be below other accumulator artefacts, as:

$$\vert {l}_{n , 0} ( {v}_{0} ) \vert = \vert {χ}_{n}^{T} ( {v}_{0} ) {w}_{0} ( {v}_{0} ) \vert \leq {10}^{\frac{γ}{20}} \vert χ ( 0 , {v}_{0} ) \vert , \qquad ( 28 )$$

for n=1, 2, . . . , M−1, where y is the peak sidelobe level in dB. Then, SNR loss is minimized in a SOCP as:

$${w}_{0}^{opt} ( {v}_{0} ) = arg min \{ η ( {v}_{0} ) = ‖ {w}_{0} ( {v}_{0} ) ‖ \} so that ( 25 ) and ( 28 ) . \qquad ( 29 )$$

In other words, the norm of coefficients vector is minimized under the equality constraint (25) and the non-equality constraints (28).

In some embodiments, the coefficient vectors are pre-computed and stored in memory 116. In this case, a coefficient vector may be designed to work sufficiently well for all the frequencies within the frequency interval [v₀−Δv, v₀+Δv]. In some embodiments, a trade-off may be made between the length of the frequency interval, which indicates the number of the vectors required to be stored in the memory, and the performance.

One way to do such design for the interval of frequencies v∈[v₀−Δv, v₀+Δv], is to formulate a SOCP to constrain the sidelobes, not only for v₀, but for a set of frequencies, vⱼ∈[v₀−Δv, v₀+Δv], ∀j=−J, −J+1, . . . , 0, . . . , J. The frequencies v; may or may not be uniformly distributed over the interval. The absolute value of a sidelobe may be represented as:

$$\vert {l}_{n , 0} ( {v}_{j} ) \vert = \vert {χ}_{n}^{T} ( {v}_{j} ) {w}_{0} ( {v}_{0} ) \vert \leq {10}^{\frac{γ}{20}} \vert χ ( 0 , {v}_{0} ) \vert \qquad ( 30 )$$

for n=1, 2, . . . , M−1, and j=−J, −J+1, . . . , 0, . . . , J. Then, SNR loss at v₀ is minimized in a SOCP as:

$${w}_{0}^{opt} ( {v}_{0} ) = arg min \{ η ( {v}_{0} ) = ‖ {w}_{0} ( {v}_{0} ) ‖ \} so that ( 25 ) and ( 30 ) . \qquad ( 31 )$$

$${w}_{0}^{opt} ( {v}_{0} )$$

may the be used as

$${w}_{0}^{opt} ( v ) ,$$

∀v∈[v₀−Δv, v₀+Δv]. The norm of coefficients vector is minimized under the equality constraint (25) and the non-equality constraints (30). It is noted that in equation (30) the main lobe for Vito is not constrained. Also, the sidelobes for v_{j≠0} are constrained in level with regards to the main lobe for v₀ and not their corresponding main lobe. These facts may considerably simplify the SOCP formulation.

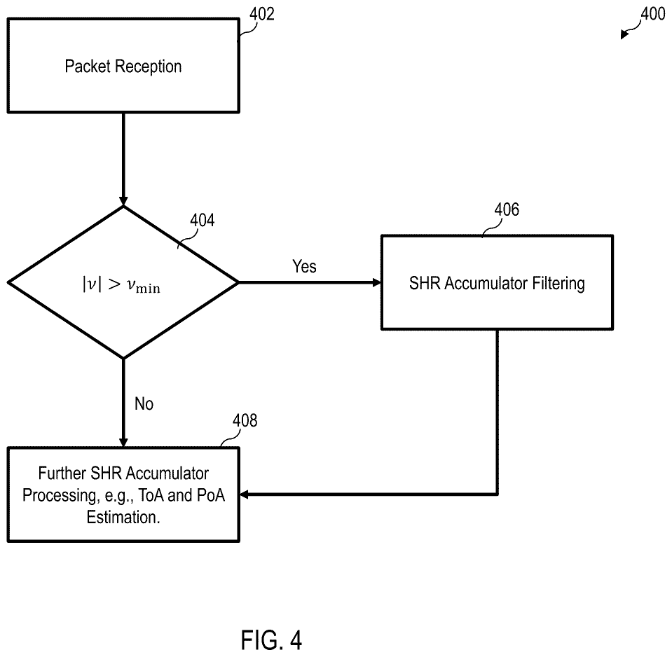

FIG. 4 shows a method 400 to determine when to start the filtering operation, according to some embodiments. FIG. 4 may be described in view of FIG. 1 for the ease of illustration.

At step 402, packet reception is performed. Referring back to FIG. 1, receiver 100 may receive RF signal 101 which includes a packet with a SHR containing a sequence of chips (e.g., +1 s and −1 s). The packet reception may include operations performed by antenna 104, RF and Baseband processing module 106, I/Q sampling circuit 108, correlator 110, de-rotation module 112, and accumulator 114. After the packet reception is completed, initial CIR estimate 105 may be generated by accumulator 114. During packet reception, receiver 100 (e.g., de-rotation module 112) may estimate/determine CFO v.

At step 404, if receiver 100 determines the absolute value of CFO | v| is higher than a threshold value vₘᵢₙ, receiver 100 may proceed to step 406, at which receiver 100 starts filtering initial CIR estimate 105 (shown as “SHR Accumulator Filter”). After step 406, e.g., the filtering, is completed, method 400 may proceed to step 408, at which an final CIR estimate 111, obtained from the filtering of initial CIR estimate 105, may be used for further processing to compute parameters such as ToA and/or position of arrival (PoA) estimation (shown as “Further SHR Accumulator Processing”). If receiver 100 determines the absolute value of CFO |v| is equal to or lower than threshold value vₘᵢₙ, receiver 100 may proceed directly to step 408, at which initial CIR estimate 105 may be used for further processing to compute parameters such as ToA and/or position of arrival (PoA) estimation.

In some embodiments, for perfect PACF sequences, or sequences with good but not perfect PACF, such as m-sequences, the accumulator filtering might not be needed for low absolute values of v (e.g., |v|≤vₘᵢₙ).

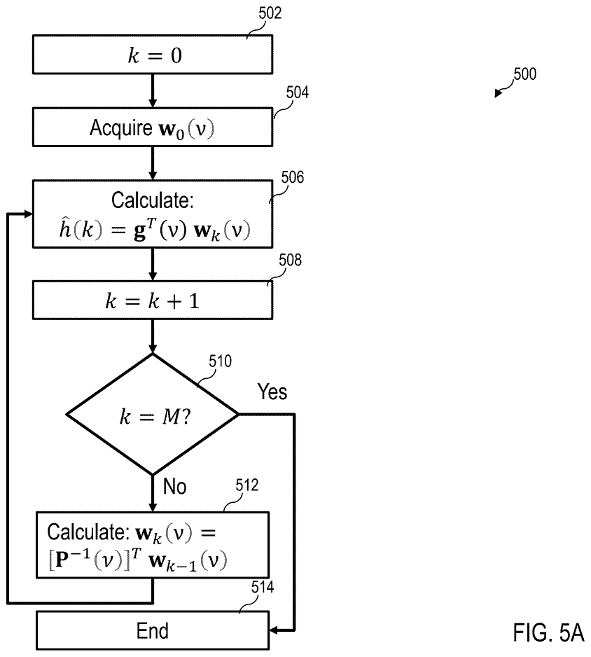

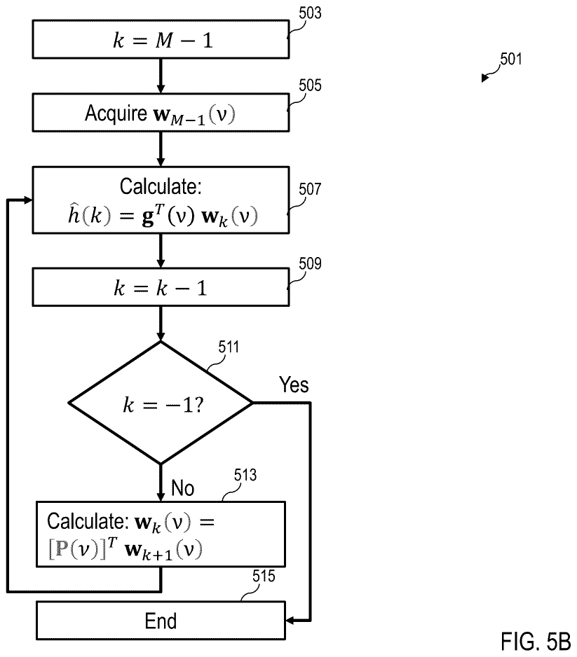

FIGS. 5A and 5B show methods 500 and 501, each being a different approach to generate coefficient vectors for each samples in the accumulator for M samples. It is assumed that the index number of the sample k is equal to 0, 1, . . . , M−1. Methods 500 and 501 may each be part of step 406. FIG. 5A may be described in view of FIGS. 1 and 3A, and FIG. 5B may be described in view of FIGS. 1 and 3B for the ease of illustration. In some embodiments, methods 500 and 501 are performed by post-processing module 102.

FIG. 5A shows a method 500 to generate coefficient vectors for each sample, according to some embodiments. In method 500, the coefficient vector for the first sample, w₀(v) may first be generated and used for determining coefficient vectors for other samples. Method 500 represents a “forward” procedure, in which the coefficient vector of a sample is determined based on the coefficient vector of a previous sample.

At step 502, method 500 starts with index number k=0, corresponding to the first sample.

At step 504, post-processing module 102 may acquire w₀(v), e.g., from memory 116. In some embodiments, w₀(v) is pre-computed and stored in memory 116.

At step 506, post-processing module 102 may calculate a final CIR estimate ĥ (n) (e.g., 111) based on the value of the accumulator g(v) (e.g., 114) and the filter coefficients wₖ(v): ĥ(n)=g^{T}(v) wₖ(v), e.g., equation (15) for the current k value (or current sample).

At step 508, post-processing module 102 may increase the k value by 1, e.g., for the computation for the next sample.

At step 510, post-processing module 102 may determine whether k is equal to M. If k is equal to M, method 500 may proceed to step 514, which is the end of filtering. If k is not equal to M, e.g., k is less than M, method 500 may proceed to step 512, at which post-processing module 102 may calculate wₖ(v)=[P⁻¹(v)]^{T} wₖ₋₁ (v), e.g., equation (18) for the current k value (or the next sample). After step 512 is completed, method 500 may be directed back step 506. In some embodiments, step 512 may be implemented in a shift register, as described in FIG. 3A.

FIG. 5B shows a method 501 to generate coefficient vectors for each sample, according to some embodiments. In method 501, the coefficient vector for the last sample, w_{M-1}(v) may first be generated and used for determining coefficient vectors for other samples. Method 501 represents a “backward” procedure, in which the coefficient vector of a sample is determined based on the coefficient vector of a next sample.

At step 503, method 501 starts with index number k=M−1, corresponding to the last sample.

At step 505, post-processing module 102 may acquire w_{M-1}(v), e.g., from memory 116. In some embodiments, w_{M-1}(v) is pre-computed and stored in memory 116.

At step 507, post-processing module 102 may calculate a final CIR estimate ĥ(n) (e.g., 111) based on the analytical model g(v) of the output of accumulator (e.g., 114) and the filter coefficients wₖ(v): ĥ(n)=g^{T}(v) wₖ(v), e.g., equation (15) for the current k value (or current sample).

At step 509, post-processing module 102 may decrease the k value by 1, e.g., for the computation for the previous sample.

At step 511, post-processing module 102 may determine whether k is equal to −1.

If k is equal to −1, method 500 may proceed to step 515, which is the end of filtering. If k is not equal to −1, e.g., k is greater than −1, method 500 may proceed to step 513, at which post-processing module 102 may calculate wₖ(v)=[P(v)]^{T}wₖ₊₁(v), e.g., equation (21) for the current k value (or the previous sample). After step 513 is completed, method 501 may be directed back step 507. In some embodiments, step 513 may be implemented in a shift register, as described in FIG. 3B.

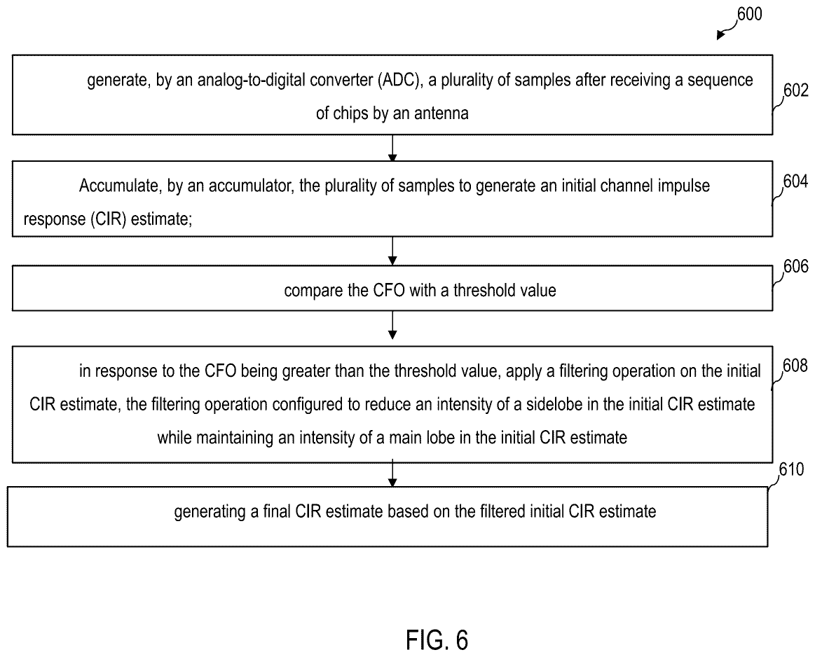

FIG. 6 is a flowchart of a method 600 for a receiver (e.g., 100) to perform a filtering operation on the output of an accumulator to generate a final CIR estimate with suppressed sidelobes/replica, according to some embodiments of the present disclosure. Method 600 is merely an example, and is not intended to limit the present disclosure beyond what is explicitly recited in the claims. Additional operations can be provided before, during, and after the method 600, and some operations described can be replaced, eliminated, or moved around for additional embodiments of method 600. Method 600 will be described in more detail below. For ease of illustration, method 300 is described in view of FIGS. 1 and 4.

At step 602, an ADC (e.g., 108) may generate a plurality of samples after receiving a sequence of chips (e.g., the SHR of RF signal 101) by an antenna (e.g., 104).

At step 604, an accumulator (e.g., 114) may accumulate the plurality of samples to generate an initial CIR estimate (e.g., 105).

At step 606, de-rotation module 112 may compare the CFO with a threshold value (e.g., vₘᵢₙ).

At step 608, in response to the CFO being greater than the threshold value, post-processing module 102 may apply a filtering operation (e.g., step 406) on the initial CIR estimate, the filtering operation configured to reduce an intensity of a sidelobe in the initial CIR estimate while maintaining an intensity of a main lobe in the initial CIR estimate.

At step 610, the post-processing module 102 may generate a final CIR estimate (e.g., 111) based on the filtered initial CIR estimate.

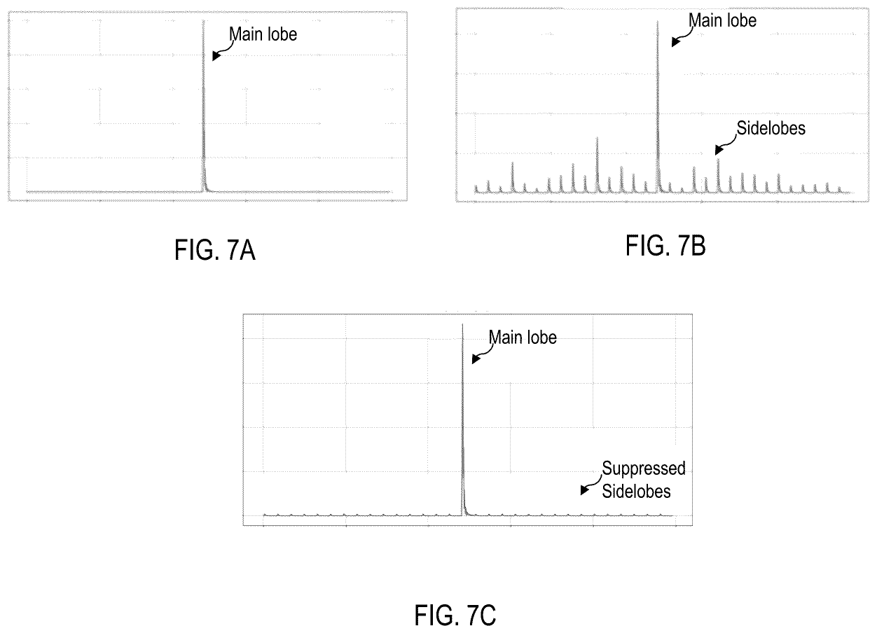

FIGS. 7A-7C shows simulation results comparing CIR estimates, in an example frequency channel, with and without filtering operation provided by the present disclosure. The x-axis may represent the accumulator index, and the y-axis may represent the absolute values of the output of an accumulator (e.g., 114). CIRs shown in FIGS. 7A-7C may be accumulated by an accumulator (e.g., 114) from a same SHR sequence such as an Ipatov sequence. FIG. 7A shows an ideal reference CIR with a main lobe but without any sidelobes. FIG. 7B shows an example of an initial CIR estimate (e.g., 105) caused by a nonzero CFO (e.g., about 40 parts per million or ppm). As shown in FIG. 7B, the initial CIR estimate may include a main lobe of a slightly reduced intensity (compared to that in FIG. 7A) and a plurality of sidelobes/replica. FIG. 7C shows an example of a final CIR estimate (e.g., 111) generated by performing a filtering operation of the present disclosure on the initial CIR estimate in FIG. 7B. The filtering operation may suppress the intensities of the sidelobes, while maintaining the intensity of the main lobe. Compared to FIG. 7B, the intensities of the sidelobes in FIG. 7C are effectively suppressed, while the intensity of the main lobe stays at least substantially the same. In various other embodiments, sidelobes in other frequency channels may also be suppressed using the method of the present disclosure.

It should be noted that, in the present disclosure, at least one of the operations (e.g., front-end processing, I/Q sampling, de-rotation, cross-correlation, accumulation, post-processing, etc.) performed by a receiver or a module (e.g., 102, 106, 108, 110, 112, and/or 114) are implemented by a specialized hardware (such as an application-specific integrated circuit (ASIC) and/or a digital signal processor (DSP)), and/or or a general-purpose processor.

Those skilled in the art will recognize improvements and modifications to the preferred embodiments of the present disclosure. All such improvements and modifications are considered within the scope of the concepts disclosed herein and the claims that follow.

1. A method for suppressing channel replica caused by carrier frequency offset (CFO), comprising:
generating, by an analog-to-digital converter (ADC), a plurality of samples after receiving a sequence of chips by an antenna;
accumulating, by an accumulator, the plurality of samples to generate an initial channel impulse response (CIR) estimate;
comparing the CFO with a threshold value;
in response to the CFO being greater than the threshold value, applying a filtering operation on the initial CIR estimate, the filtering operation configured to reduce an intensity of a sidelobe in the initial CIR estimate while maintaining an intensity of a main lobe in the initial CIR estimate; and
generating a final estimated CIR based on the filtered initial CIR estimate.

2. The method of claim 1, further comprising:
determining an ambiguity function of the sequence;
determining an analytical model of the initial CIR estimate based on the ambiguity function and a channel response of the sequence; and
generating a set of filter coefficient vectors of the filter based on the ambiguity function, wherein the set of the filter coefficient vectors each correspond to a respective one of the plurality of samples.

3. The method of claim 2, wherein the applying of the filtering operation comprises generating an inner product of each of the filter coefficient vector with the initial CIR estimate.

4. The method of claim 2, wherein the ambiguity function comprises samples arranged in a Toeplitz matrix and comprises a pseudo-circulant matrix.

5. The method of claim 2, wherein the generating of the set of filter coefficient vectors comprises:
generating one filter coefficient vector of the filter coefficient vectors; and
generating an adjacent filter coefficient vector of the one filter coefficient vectors based on the pseudo-circulant matrix.

6. The method of claim 5, wherein the generating of the set of filter coefficients comprises:
generating a first filter coefficient vector of the filter coefficient vectors; and
generating a next filter coefficient vector by:
multiplying a last element of a previous filter coefficient vector with a phase factor to generate a product, and
shifting the product to be a first element and a remaining of elements by one position to the right.

7. The method of claim 5, wherein the generating of the set of filter coefficient vectors comprises:
generating a last filter coefficient vector of the filter coefficient vectors; and
generating a previous filter coefficient vector by:
multiplying a first element of a next filter coefficient vector with a phase factor to generate a product, and
shifting the product to be a last element and a remaining of elements by one position to the left.

8. The method of claim 5, wherein a first filter coefficient vector or a last filter coefficient vector is pre-computed based on a total sidelobe suppression or a convex optimization.

9. The method of claim 5, wherein the shifting is performed in a shift register.

10. The method of claim 1, wherein the sequence comprises a synchronization header (SHR) of a radio frequency (RF) packet.

11. The method of claim 1, further comprising computing one or more of a time of arrival (ToA) or a position of arrival (PoA) based on the final CIR estimate.

12. An ultra-wideband (UWB) device, comprising a UWB receiver comprising an analog-to-digital converter (ADC), wherein the UWB receiver is configured to:
generate, by the ADC, a plurality of samples after receiving a sequence of chips by an antenna;
accumulate, by an accumulator, the plurality of samples to generate an initial channel impulse response (CIR) estimate;
compare the CFO with a threshold value;
in response to the CFO being greater than the threshold value, apply a filtering operation on the initial CIR, the filtering operation configured to reduce an intensity of a sidelobe in the initial CIR estimate while maintaining an intensity of a main lobe in the initial CIR estimate; and
generate a final estimated CIR based on the filtered initial CIR estimate.

13. The UWB device of claim 12, wherein the UWB receiver is further configured to:
determine an ambiguity function of the sequence;
determine an analytical model of the initial CIR estimate based on the ambiguity function; and
generate a set of filter coefficient vectors of the filter based on the ambiguity function, wherein the set of the filter coefficient vectors each correspond to a respective one of the plurality of samples.

14. The UWB device of claim 13, wherein to apply the filtering operation comprises generating an inner product of each of the filter coefficient vector with a respective part of the initial CIR estimate that corresponds to the respective one of the plurality of samples.

15. The UWB device of claim 13, wherein the ambiguity function comprise samples arranged in a Toeplitz matrix and comprises a pseudo-circulant matrix.

16. The UWB device of claim 13, wherein to generate the set of filter coefficient vectors comprises:
generating one filter coefficient vector of the filter coefficient vectors; and
generating an adjacent filter coefficient vector of the one filter coefficient vectors based on the pseudo-circulant matrix.

17. The UWB device of claim 16, wherein to generate the set of filter coefficients comprises:
generating a first filter coefficient vector of the filter coefficient vectors; and
generating a next filter coefficient vector by:
multiplying a last element of a previous filter coefficient vector with a phase factor to generate a product, and
shifting the product to be a first element and a remaining of elements by one position to the right.

18. The UWB device of claim 16, wherein to generate the set of filter coefficient vectors comprises:
generating a last filter coefficient vector of the filter coefficient vectors; and
generating a previous filter coefficient vector by:
multiplying a first element of a next filter coefficient vector with a phase factor to generate a product, and
shifting the product to be a last element and a remaining of elements by one position to the left.

19. The UWB device of claim 16, wherein the shifting is performed in a shift register.

20. A non-transitory computer-readable medium (CRM) having program code recorded thereon, the program code comprising:
code for causing an ultra-wide band (UWB) device to generate, by an analog-to-digital converter (ADC), a plurality of samples after receiving a sequence of chips by an antenna;
code for causing the UWB device to accumulate, by an accumulator, the plurality of samples to generate an initial channel impulse response (CIR);
code for causing the UWB device to compare the CFO with a threshold value;
code for causing the UWB device to, in response to the CFO being greater than the threshold value, apply a filtering operation on the initial CIR estimate, the filtering operation configured to reduce an intensity of a sidelobe in the initial CIR estimate while maintaining an intensity of a main lobe in the initial CIR estimate; and
code for causing the UWB device to generate an estimated CIR based on the filtered initial CIR estimate.
